(19) United States
(12) Patent Application Publication
(10) Pub. No.: US 2004/0063857 A1
(43) Pub. Date: Apr. 1, 2004

(54) Polymer blends based on polyamide

(76) Inventors: Marc Vathauer, Koln (DE); Detlev Joachimi, Krefeld (DE)

Correspondence Address: BAYER POLYMERS LLC, 100 BAYER ROAD, PITTSBURGH, PA, 15205, US

(21) Appl. No.: 10/623,777

(22) Filed: Jul. 21, 2003

(30) Foreign Application Priority Data
Jul. 22, 2002 (DE) 10233170.7

(51) Int. Cl. C08L 51/00; C08L 77/00

(52) U.S. Cl. 525/63; 524/512; 524/500; 524/502; 524/504; 524/505; 525/66

(57) ABSTRACT

A molding composition that features low water absorption, low thermal expansion and mold shrinkage is disclosed. The composition that optionally contains fillers or reinforcing agents contains polyamide, an impact modifier and a member selected from the group consisting of phenol-formaldehyde resin, an oligomeric or polymeric compound having at least 2 phenolic hydroxyl groups per molecule. Further optional components are compatibility promoter and a vinyl (co)polymer.

### FIELD OF THE INVENTION

The invention relates to molding compositions and more particularly to impact-modified polyamide compositions.

### SUMMARY OF THE INVENTION

A molding composition that features low water absorption, low thermal expansion and mold shrinkage is disclosed. The composition that optionally contains fillers or reinforcing agents contains polyamide, an impact modifier and a member selected from the group consisting of phenol-formaldehyde resin, an oligomeric or polymeric compound having at least 2 phenolic hydroxyl groups per molecule. Further optional components are compatibility promoter and a vinyl (co)polymer.

### TECHNICAL BACKGROUND OF THE INVENTION

A major advantage of impact-modified polyamide molding compositions is their outstanding chemical resistance and high heat resistance. These molding compositions, in particular those based on aliphatic polyamides such as, for example, PA-66 and PA-6, are therefore suitable, inter alia, for use in exterior vehicle body components.

A further important property is the dimensional stability of the molding which is produced. In this respect water absorption by the polyamide is perceived as disruptive, leading to an alteration in the properties of the plastics material, in particular the dimensional stability. Although polyamides exist which absorb little or no water (PA 11, PA 12, partially aromatic copolyamides), their heat resistance is inadequate, in some cases they are too brittle, and they are in any case more costly than PA-6 and PA-66.

A hydrophobing reagent is frequently added in order to reduce the moisture absorption of aliphatic polyamides such as polyamide-6 and polyamide-66 or corresponding copolyamides in thermoplastic molding compositions.

U.S. Pat. No. 5,670,576 describes a blend of polyphenylene ether (PPE) and polyamide, which contains a phenol novolak resin in order to lower the water absorption. This patent specification moreover mentions the good flame resistance of the claimed molding composition; nothing is stated with regard to coefficients of thermal expansion.

U.S. Pat. No. 4,970,272 describes a polyamide-PPE blend to which a phenolic hydrophobing reagent is added. A low water absorption is described while the good mechanical properties remain unchanged.

U.S. Pat. No. 4,849,474 describes a polyamide provided with a phenolic additive and having lower water absorption. Phenol-formaldehyde resins are not mentioned.

EP-A 0 240 887 describes molding compositions prepared from polyamide, a rubber and a bisphenol, which show an improved ease of flow brought about by the additive.

DE-A 32 48 329 describes the addition of phenolic compounds to polyamide in order to reduce water absorption. Phenol-formaldehyde resins are not mentioned.

The object of the present invention was to provide polyamide molding compositions which have low water absorption, low thermal expansion and low molding shrinkage. The reduction in the elastic modulus when water is absorbed should additionally be reduced to a minimum. The compositions according to the invention have the desired properties.

### DETAILED DESCRIPTION OF THE INVENTION

The present invention therefore provides a polymeric molding composition which comprise

(A) from 40 to 90, preferably 45 to 85, particularly preferably 45 to 75 parts by weight polyamide

(B) from 0.5 to 50, preferably 1 to 30, particularly preferably 1 to 25, in particular 4 to 25 parts by weight impact modifier

(C) from 0 to 50 parts by weight, preferably 7 to 40, in particular 10 to 35 parts by weight fillers and reinforcing materials and

(D) from 0.1 to 15, preferably 1 to 12, particularly preferably 2 to 8 parts by weight phenol-formaldehyde resin or an oligomeric or polymeric compound having at least 2 phenolic OH groups and being different from phenol-formaldehyde resins.

The compositions according to the invention may further contain

(E) compatibility promoter and/or

(F) vinyl (co)polymer.

It has been found that the above composition has a lower water absorption than a composition that does not contain component (D), and features a coefficient of linear expansion which is substantially lower than that of other water repellent agents, and a lower molding shrinkage and higher modulus in the conditioned state.

Component A

Polyamides which are suitable according to the invention are homopoly-amides, copolyamides and mixtures of these polyamides. These may be partially crystalline and/or amorphous polyamides. Polyamide-6, polyamide-66, their mixtures and corresponding copolymers prepared from these components are among the suitable partially crystalline polyamides. Further suitable are partially crystalline polyamides where the acid component is wholly or partially terephthalic acid and/or isophthalic acid and/or suberic acid and/or sebacic acid and/or azelaic acid and/or adipic acid and/or cyclohexanedicarboxylic acid, and where the diamine component is wholly or partially m- and/or p-xylylenediamine and/or hexamethylenediamine and/or 2,2,4-trimethylhexamethylene diamine and/or 2,4,4-trimethylhexamethylene diamine and/or isophorone diamine.

Moreover, polyamides which are prepared wholly or partially from lactams having 7 to 12 C atoms in the ring, optionally used together with one or more of the aforementioned starting components, are included among the suitable polyamides.

Particularly preferred partially crystalline polyamides are polyamide-6 and polyamide-66 and mixtures thereof. Known products may be utilized as amorphous polyamides. They are obtained by polycondensation of diamines such as ethylenediamine, hexamethylene diamine, decamethylene diamine, 2,2,4-and/or 2,4,4-trimethylhexamethylene diamine, m- and/or p-xylylene diamine, bis(4-aminocyclohexyl) methane, bis(4-aminocyclohexyl) propane, 3,3′-dimethyl-4,4′-diaminodicyclohexyl methane, 3-aminomethyl-3,5,5-trimethylcyclohexylamine, 2,5- and/or 2,6-bis(aminomethyl) norbornane and/or 1,4-diaminomethylcyclohexane with dicarboxylic acids such as oxalic acid, adipic acid, azelaic acid, decanedicarboxylic acid, heptadecanedicarboxylic acid, 2,2,4-and/or 2,4,4-trimethyladipic acid, isophthalic acid and terephthalic acid.

Copolymers obtained by polycondensation of a plurality of monomers are also suitable, as are copolymers prepared with the addition of aminocarboxylic acids such as ε-aminohexanoic acid, ω-aminoundecanoic acid or ω-aminolauric acid or lactams thereof.

Particularly suitable amorphous polyamides are those polyamides which are prepared from isophthalic acid, hexamethylene diamine and further diamines such as 4,4-diaminodicyclohexyl methane, isophorone diamine, 2,2,4- and/or 2,4,4-trimethylhexamethylene diamine, 2,5- and/or 2,6-bis(aminomethyl) norbornene; or from isophthalic acid, 4,4′-diaminodicyclohexyl methane and 4,4′-diaminocaprolactam; or from isophthalic acid, 3,3′-dimethyl-4,4′-diaminodicyclohexyl methane and laurinlactam; or from terephthalic acid and the isomer mixture of 2,2,4- and/or 2,4,4-trimethylhexamethylene diamine.

In place of pure 4,4′-diaminodicyclohexyl methane, mixtures of the positionally isomeric diaminodicyclohexal methanes, which are composed of

| | |
|---|---|
| from 70 to 99 mol. % | of the 4,4′-diamino isomer |
| from 1 to 30 mol. % | of the 2,4′-diamino isomer |
| from 0 to 2 mol. % | of the 2,2′-diamino isomer, |

optionally corresponding to more highly condensed diamines obtained by hydrogenation of technical grade diaminodiphenyl methane may be utilized. Up to 30% of the isophthalic acid may be replaced by terephthalic acid.

The polyamides may be utilized alone or in any mixture.

The polyamides preferably have a relative viscosity (measured on a 1 wt. % solution in m-cresol at 25° C.) of from 2.0 to 5.0, particularly preferably 2.5 to 4.0.

Component B

One or more components, for example copolymers and/or graft polymers, may be utilized as the component B. In the case of graft polymers these are preferably graft polymers of

B.1 from 5 to 95, preferably 30 to 90 wt. % of at least one vinyl monomer

on

B.2 from 95 to 5, preferably 70 to 10 wt. % of one or more graft backbones having glass transition temperatures <10° C., preferably <0° C., particularly preferably <−20° C.

The graft backbone B.2 generally has an average particle size (d₅₀ value) of from 0.05 to 5 μm, preferably 0.10 to 2 μm, particularly preferably 0.20 to 1 μm, in particular 0.2 to 0.5 μm.

Monomers B.1 are preferably mixtures of

B.1.1 from 50 to 99 wt. % vinyl aromatics and/or vinyl aromatics substituted in the ring (such as, for example, styrene, α-methyl styrene, p-methyl styrene, p-chlorostyrene) and/or (meth)acrylic acid-(C₁-C₈)-alkyl ester (such as, for example, methyl methacrylate, ethyl methacrylate) and

B.1.2 from 1 to 50 wt. % vinyl cyanides (unsaturated nitrites such as acrylonitrile and methacrylonitrile) and/or (meth)acrylic acid-(C₁-C₈)-alkyl ester (such as, for example, methyl methacrylate, n-butyl acrylate, t-butyl acrylate) and/or derivatives (such as anhydrides and imides) of unsaturated carboxylic acids (for example maleic acid anhydride and N-phenyl maleinimide).

Preferred monomers B.1.1 are at least one of the monomers styrene, α-methyl styrene and methyl methacrylate, preferred monomers B.1.2 are at least one of the monomers acrylonitrile, maleic acid anhydride and methyl methacrylate.

Particularly preferred monomers are B.1.1 styrene and B.1.2 acrylonitrile.

Graft backbones B.2 which are suitable for the graft polymers B are, for example, diene rubbers, EP(D)M rubbers, that is to say those based on ethylene/propylene and optionally diene, polyacrylate rubber, polyurethane rubber, silicone rubber, chloroprene and ethylene/vinyl acetate rubber.

Preferred graft backbones B.2 are diene rubbers. Diene rubbers within the meaning of the present invention are understood to include diene rubbers, for example, based on butadiene, isoprene, and the like, or mixtures of diene rubbers, or copolymers of diene rubbers or mixtures thereof with further copolymerized monomers (for example in accordance with B.1.1 and B.1.2), preferably butadiene-styrene copolymers, provided that the glass transition temperature of the component B.2 is less than <10° C., preferably <0° C., particularly preferably <−10° C.

Pure polybutadiene rubber is particularly preferred.

Particularly preferred polymers B are, for example, ABS polymers (emulsion, bulk and suspension ABS), such as are described, for example in DE-OS 2 035 390 (=U.S. Pat. No. 3,644,574) or in DE-OS 2 248 242 (=GB-PS 1 409 275) or in Ullmann, Enzyklopädie der Technischen Chemie, Vol. 19 (1980), p. 280 et seq.

The gel content of the graft backbone B.2 is at least 30 wt. %, preferably at least 40 wt. % (measured in toluene).

The graft copolymers B may be prepared by radical polymerisation, for example by emulsion, suspension, solution or bulk polymerisation, preferably by emulsion polymerisation or bulk polymerisation.

Particularly suitable graft rubbers also include ABS polymers which are prepared by redox initiation with an initiator system prepared from organic hydroperoxide and ascorbic acid according to U.S. Pat. No. 4,937,285.

Since it is known that the graft monomers are not necessarily grafted completely onto the graft backbone in the grafting reaction, according to the invention graft polymers B are understood also to include products such as are obtained by (co)polymerization of the graft monomers in the presence of the graft backbone and such as result during working-up.

Suitable polyacrylate rubbers according to B.2 of the polymers B are preferably polymers prepared from acrylic acid alkyl esters, optionally having up to 40 wt. %, in relation to B.2, of other polymerizable, ethylenically unsaturated monomers. The preferred polymerizable acrylic acid esters include C₁-C₈-alkyl esters, for example methyl, ethyl, butyl, n-octyl and 2-ethylhexyl esters; haloalkyl esters, preferably halo-C₁-C₈-alkyl esters, such as chloroethyl acrylate, as well as mixtures of these monomers.

For the purpose of cross-linking, monomers having more than one polymerisable double bond may be copolymerized. Preferred examples of cross-linking monomers are esters of unsaturated monocarboxylic acids having 3 to 8 C atoms and unsaturated monohydric alcohols having 3 to 12 C atoms or saturated polyols having 2 to 40H groups and 2 to 20 C atoms, such as, for example, ethylene glycol dimethacrylate, allyl methacrylate; heterocyclic compounds having multiple unsaturation, such as, for example, trivinyl and triallyl cyanurate; polyfunctional vinyl compounds such as divinyl benzenes and trivinyl benzenes; also suitable are triallyl phosphate and diallyl phthalate.

Preferred cross-linking monomers are allyl methacrylate, ethylene glycol dimethacrylate, diallyl phthalate and heterocyclic compounds which have at least 3 ethylenically unsaturated groups.

Particularly preferred cross-linking monomers are the cyclic monomers triallyl cyanurate, triallyl isocyanurate, triacryloyl hexahydro-s-triazine, triallylbenzenes. The quantity of the cross-linked monomers is preferably from 0.02 to 5, in particular 0.05 to 2 wt. %, in relation to the graft backbone B.2.

In the case of cyclic cross-linking monomers having at least 3 ethylenically unsaturated groups, it is advantageous to limit the quantity to less than 1 wt. % of the graft backbone B.2.

Preferred “other” polymerizable, ethylenically unsaturated monomers which may optionally serve in addition to the acrylic acid esters to prepare the graft backbone B.2 are, for example, acrylonitrile, styrene, α-methyl styrene, acrylamides, vinyl-C₁-C₆-alkyl ethers, methyl methacrylate, butadiene. Preferred polyacrylate rubbers as the graft backbone B.2 are emulsion polymers which have a gel content of at least 60 wt. %.

Further suitable graft backbones according to B.2 are silicone rubbers having grafting-active sites, such as are described in DE-OS 3 704 657, DE-OS 3 704 655, DE-OS 3 631 540 and DE-OS 3 631 539.

The gel content of the graft backbone B.2 is determined at 25° C. in a suitable solvent (M. Hoffmann, H. Krömer, R. Kuhn, Polymeranalytik I and II, Georg Thieme-Verlag, Stuttgart 1977).

The median particle size (d₅₀) is the diameter above and below which, respectively, 50 wt. % of the particles lie. It may be determined by means of ultracentrifuge measurement (W. Scholtan. H. Lange, Kolloid-Z. and Z. Polymere 250 (1972), 782-1796).

Further rubber-elastic polymers which are considered for B are presented hereinbelow.

Such polymers are described, for example, in Houben-Weyl, Methoden der organischen Chemie, Vol. 14/1 (Georg Thieme-Verlag, Stuttgart, 1961), pp. 392 to 406 and in the monograph by C. B. Bucknall, “Toughened Plastics” (Applied Science Publishers, London, 1977).

Preferred elastomers are the so-called ethylene-propylene (EPM) or ethylene-propylene-diene (EPDM) rubbers.

In general EPM rubbers have virtually no double bonds left, while EPDM rubbers may have from 1 to 20 double bonds/100 C atoms.

The following are included as suitable diene monomers for EPDM rubbers: conjugated dienes such as isoprene and butadiene, non-conjugated dienes having 5 to 25 C atoms, such as penta-1,4-diene, hexa-1,4-diene, hexa-1,5-diene, 2,5-dimethylhexa-1,5-diene and 2,5-dimethylocta-1,4-diene, cyclic dienes such as cyclopentadiene, cyclohexadienes, cyclooctadienes and dicyclopentadiene as well as alkenyl norbornenes such as 5-ethylidene-2-norbornene, 5-butylidene-2-norbornene, 2-methallyl-5-norbornene, 2-isopropenyl-5-norbornene and tricyclodienes such as 3-methyl-tricyclo(5.2.1.0.2.6)-3,8-decadiene or mixtures thereof. Hexa-1,5-diene, 5-ethylidenenorbornene and dicyclopentadiene are preferred. The diene content of the EPDM rubbers is preferably from 0.5 to 50, in particular 1 to 8 wt. %, in relation to the total weight of the rubber.

EPM or EPDM rubbers may preferably also be grafted with reactive carboxylic acids or derivatives thereof. Acrylic acid, methacrylic acid and derivatives thereof, for example glycidyl (meth)acrylate, as well as maleic acid anhydride, for example, are suitable in this context.

Component C

Glass fibers, optionally chopped or ground, glass beads, glass spheres, reinforcing material in the form of flakes, such as kaolin, talc, mica, silicates, quartz, talcum, titanium dioxide, wollastonite, carbon fibers or a mixture thereof are examples of filler and reinforcing materials which may be included. Chopped or ground glass fibers are preferably utilized as a reinforcing material. Glass spheres, mica, silicates, quartz, talcum, titanium dioxide, wollastonite and kaolin are preferred fillers which may also have a reinforcing effect. Kaolin, talc and wollastonite are particularly preferred.

Component D

Resins which are suitable according to the invention are known or may be prepared by known processes.

These may be prepared by condensation reaction of phenols with aldehydes, preferably formaldehyde, by derivatization of the condensates resulting therefrom or by an addition reaction between phenols and unsaturated compounds such as, for example, acetylene, terpenes, and the like.

The condensation may here be acid or basic, and the molar ratio of aldehyde to phenol may be from 1:0.4 to 1:2.0. Here, oligomers or polymers having a molecular weight of in general 150-5 000 g/mol arise.

Component E

Thermoplastic polymers having polar groups are preferably suitable as a compatibility promoter E).

According to the invention, a polymer produced from

E.1 a vinyl-aromatic monomer,

E.2 at least one monomer selected from the group comprising C₂ to C₁₂-alkyl methacrylates, C₂ to C₁₂-alkyl acrylates, methacrylonitriles and acrylonitriles and

E.3 α, β-unsaturated components which comprise dicarboxylic acid anhydrides,

is preferably utilized.

Styrene is particularly preferred as vinyl-aromatic monomers E.1.

Acrylonitrile is particularly preferred for the component E.2.

Maleic acid anhydride is particularly preferred for the α, β-unsaturated components which comprise dicarboxylic acid anhydrides E.3.

Terpolymers of the monomers named are preferably utilized as the component E.1, E.2 and E.3. Accordingly, terpolymers of styrene, acrylonitrile and maleic acid anhydride are preferably utilized. These terpolymers contribute in particular to the improvement of mechanical properties such as tensile strength and weathering resistance. The quantity of maleic acid anhydride in the terpolymer may vary within broad limits. The quantity of maleic acid anhydride in component

E is preferably from 0.2 to 5 mol. %. Quantities of between 0.5 and 1.5 mol. % are particularly preferred. Particularly good mechanical properties in terms of tensile strength and weathering resistance are achieved within this range.

The terpolymer may be prepared in a known manner. A suitable method is dissolution of the monomer components of the terpolymer, for example the styrene, maleic acid anhydride or acrylonitrile, in a suitable solvent, for example methyl ethyl ketone (MEK). One or optionally more chemical initiators are added to this solution. Suitable initiators are, for example, peroxides. The mixture is afterwards polymerized at elevated temperature for several hours. The solvent and the unreacted monomers are then removed in a known manner.

The ratio of the component E.1 (vinyl-aromatic monomer) to the component E.2, for example the acrylonitrile monomer in the terpolymer, is preferably between 80:20 and 50 50. In order to improve the miscibility of the terpolymer with the graft copolymer B, a quantity of vinyl-aromatic monomer E.1 is preferably selected which corresponds to the quantity of the vinyl monomer B.1 in the graft copolymer B.

The quantity of the component E in the composition according to the invention is between 0 and 50 parts by weight, preferably between 1 and 30 parts by weight, particularly preferably between 2 and 10 parts by weight. Quantities of between 3 and 7 parts by weight are the most preferred.

Polymers suitable as Component E are described, for example, in U.S. patents U.S. Pat. No. 5,756,576 and U.S. Pat. No. 4,713,415 that are incorporated herein by reference. In particular the polymers named in EP-A-202 214 (U.S. Pat. No. 4,713,415) are preferred according to the invention.

Component F

The component F embraces one or more rubber-free thermoplastic vinyl (co)polymers.

Polymers of at least one monomer from the group comprising vinyl aromatics, vinyl cyanides (unsaturated nitrites) and methacrylic acid-(C₁-C₈)-alkyl esters are suitable as the vinyl (co)polymers. (Co)polymers of

F.1 from 50 to 99, preferably 60 to 80 wt. % vinyl aromatics and/or vinyl aromatics substituted in the ring, such as, for example, styrene, α-methyl styrene, p-methyl styrene, p-chlorostyrene) and/or methacrylic acid-(C₁-C₈)-alkyl esters such as, for example, methyl methacrylate, ethyl methacrylate), and

F.2 from 1 to 50, preferably 20 to 40 wt. %, vinyl cyanides (unsaturated nitrites) such as acrylonitrile and methacrylonitrile and/or methacrylic acid-(C₁-C₈)-alkyl esters (such as, for example, methyl methacrylate, n-butyl acrylate, t-butyl acrylate)

are in particular suitable.

The (co)polymers F are resinous, thermoplastic and rubber-free.

The copolymer of F.1 styrene and F.2 acrylonitrile is particularly preferable.

The (co)polymers according to F are known and may be prepared by radical polymerization, in particular by emulsion, suspension, solution or bulk polymerization. The (co)polymers preferably have molecular weights \overline{M}_{w} (weight average, determined by light scattering or sedimentation) of between 15 000 and 200 000.

The quantity of (co)polymers component F, in the composition according to the invention is up to 30 parts by weight, preferably up to 20 parts by weight, in particular up to 10 parts by weight.

Component G

The composition according to the invention may include conventional additives such as flame retardants, anti-drip agents, inorganic compounds different from component C), lubricants and mold release agents, nucleating agents, antistatic agents, stabilizers, dyes and pigments.

The composition according to the invention may include from 0.01 to 20 wt. % flame retardants, in relation to the total molding composition. By way of example, organic halo compounds such as decabromobis-phenylether, tetrabromobisphenol, inorganic halo compounds such as ammonium bromide, nitrogen compounds such as melamine, melamine formaldehyde resins, inorganic hydroxide compounds such as Mg—Al hydroxide, inorganic compounds such as aluminium oxides, titanium dioxides, antimony oxides, barium metaborate, hydroxyantimonate, zirconium oxide, zirconium hydroxide, molybdenum oxide, ammonium molybdate, tin borate, ammonium borate, barium metaborate and tin oxide as well as siloxane compounds are among the suitable flame retardants.

Phosphorus compounds such as are described in EP-A-363 608, EP-A-345 522 or EP-A-640 655 may also be utilized as flame retardant compounds.

All data relating to parts by weight in this Application are standardised such that the sum of the parts by weight of all the components in the composition is 100.

The molding compositions according to the invention which comprise the components A) to F) and optionally further known additives such as stabilizers, dyes, pigments, lubricants and mold release agents, nucleating agents as well as antistatic agents are prepared by mixing of the respective constituents in known manner and melt-compounding and melt-extrusion at temperatures of from 200° C. to 300° C., in conventional units such as internal mixers, extruders and twin-screw extruders.

The mixing of the individual constituents may be effected in known manner, both in successive and in simultaneous manner, both at approximately 20° C. (room temperature) and at elevated temperature.

The composition of the present invention may be used for the preparation of molded articles of any type. In particular, molded articles may be produced by injection molding. Examples of molded articles which may be prepared include housing components of all types, for example for household appliances such as juice presses, coffee machines, mixers, for office machines such as computers, printers, monitors or for covering plates for the construction sector and components for the automotive sector.

The composition is particularly suitable for the production of moldings required to have particularly high heat resistance, tensile strength and stress cracking resistance.

The present invention also provides the use of the composition for the production of moldings, as well as the moldings obtained therefrom.

The invention is described in greater detail hereinbelow by reference to the following Examples.

### EXAMPLES

Components utilized:

A1: polyamide-66 (Ultramid® A3, BASF AG, Ludwigshafen, Germany)

A2: copolyamide of caprolactam and AH salt (adipic acid and hexamethylene diamine salt) having a resulting total PA-66 unit content of from 4 to 6 wt. %, ηᵣₑₗ of from 2.8 to 3.1, measured on a 1 wt. % solution in m-cresol at 25° C.

A3: polyamide-6: Durethan B35F, Bayer AG, ηᵣₑₗ of from 3.5 to 3.7, measured on a 1 wt. % solution in m-cresol at 25° C.

B1: graft polymer of 40 parts by weight of a copolymer of styrene and acrylonitrile in a ratio of 73:27 on 60 parts by weight particulate cross-linked polybutadiene rubber (median particle diameter d₅₀=0.3 μm), prepared by emulsion polymerization

B2: Exxelor® VA 1803, ExxonMobil (ethylene/propylene/maleic acid anhydride rubber)

C1: Naintsch A3 (Naintsch Mineralwerke GmbH, Graz, Austria), talc having an median particle diameter (d₅₀) of 1.2μ according to manufacturer's data

C2: Kaolin (Polarite 102A, from Imerys Minerals Ltd., England, calcined and silanized kaolinite)

D1: Rhenosin RB (phenol-formaldehyde resin), Rhein Chemie Rheinau GmbH, Mannheim

D2: Bisphenol A, Bayer AG

E: compatibility promoter: terpolymer of styrene and acrylonitrile (ratio by weight 2.1:1) comprising 1 mol. % maleic acid anhydride

F: styrene/acrylonitrile copolymer having a ratio by weight of styrene:acrylonitrile of 72:28 and an intrinsic viscosity of 0.55 dl/g (measured in dimethyl formamide at 20° C.)

G1: mold release agent

G2: Irganox® 1076, Ciba Specialities, Basle, Switzerland

G3: Irganox® P 5802, Ciba Specialities

G4: montanic ester wax (Licowax® E F1, Clariant GmbH)

G5: Irganox® 1098 (12.5% in PA-66), Ciba Specialities

G6: Irganox® 1098 (10% in PA-6), Ciba Specialities

G7: carbon black masterbatch UN 2014 (50% masterbatch in polyolefine) from Fa. Colloids.

The compositions according to the invention were prepared by conventional methods.

The elastic modulus values indicated were determined in a three-point bending test performed on 80×10×4 mm³ test specimens. The shrinkage was measured on 150×105×3 mm³ rectangular sheets which had been injection-molded at a mold temperature of 80° C. at 500 bar holding pressure.

TABLE 1

| | 1 | V1 | V2 |
|---|---|---|---|
| Components (parts by | | | |
| weight) | | | |
| A1 | 60.56 | 60.56 | 62.78 |
| B1 | 18.43 | 18.43 | 19.1 |
| C | 8.68 | 8.68 | 8.97 |
| D1 | 3.42 | — | — |
| D2 | — | 3.42 | — |
| E | 4.76 | 4.76 | 4.93 |
| F | 2.86 | 2.86 | 2.87 |
| G1 | 0.24 | 0.24 | 0.25 |
| G2 | 0.87 | 0.87 | 0.90 |
| G3 | 0.43 | 0.43 | 0.45 |
| Properties | | | |
| Elastic modulus [MPa] | 2110 | 1558 | 1850 |
| (conditioned in accord- | | | |
| ance with ISO 1110) | | | |
| Coefficient of linear | longitudinal: 75 | longitudinal: 79 | longitudinal: 85 |
| expansion* [ppm/K] | transverse: 84 | transverse: 103 | transverse: 104 |
| Moisture absorption | 1.64 | 1.71 | 1.9 |
| (conditioned in accord- | | | |
| ance with ISO 1110) | | | |

*measured at: 23° C. to 55° C.

The data in Table 1 show clearly that the utilization of the hydrophobing reagent D1 (Example 1) has advantages over a formulation having the same content (wt. %) of D2, (Example V1) with respect to the elastic modulus in the conditioned state, and also the coefficient of linear expansion.

Compared with a molding composition having no hydrophobing reagent, (Example V2) the moisture absorption when conditioned in accordance with ISO 1110 is lowered, furthermore Example 1 also shows a higher elastic modulus in the conditioned state than Example V1 Furthermore, both Example 1 and Example V1 show an improved coefficient of expansion over that of Example V2.

TABLE 2

| | 2 | V3 |
|---|---|---|
| Components (parts by weight) | | |
| A1 | 35.5 | 35.5 |
| A2 | 15 | 15 |
| B2 | 7 | 7 |
| C2 | 30 | 30 |
| D1 | 7 | — |
| D2 | — | 7 |
| G4 | 0.1 | 0.1 |
| G6 | 4 | 4 |
| G7 | 1.4 | 1.4 |
| Properties | | |
| Elastic modulus [MPa] (condi- | 1540 | 580 |
| tioned in accordance with | | |
| ISO 1110) | | |
| Coefficient of linear expansion# | longitudinal: 65 | longitudinal: 91 |
| [ppm/K] | transverse: 90 | transverse: 173 |
| Moisture absorption (conditioned | 1.99 | 2.05 |
| in accordance with ISO 1110) | | |
| Molding shrinkage [%] | longitudinal: 1.2 | longitudinal: 1.5 |
| | transverse: 1.3 | transverse: 1.5 |

#measured at: −20° C. to 23° C.

The data in Table 2 show that with the Composition 2 according to the invention, which comprises the hydrophobing agent D1, marked advantages regarding the elastic modulus in the conditioned state, the coefficient of expansion and the molding shrinkage are achieved by comparison with V3 which comprises the hydrophobing agent D2.

TABLE 3

| | 3 | V4 |
|---|---|---|
| Components (parts by weight) | | |
| A3 | 49.5 | 49.5 |
| B2 | 7 | 7 |
| C2 | 30 | 30 |
| D1 | 7 | — |
| D2 | — | 7 |
| G4 | 0.1 | 0.1 |
| G6 | 5 | 5 |
| G7 | 1.4 | 1.4 |
| Properties | | |
| Elastic modulus [MPa] (condi- | 1680 | 700 |
| tioned in accordance with | | |
| ISO 1110) | | |
| Coefficient of linear expansion# | longitudinal: 66 | longitudinal: 94 |
| [ppm/K] | transverse: 81 | transverse: 87 |
| Moisture absorption (conditioned | 2.13 | 2.14 |
| in accordance with ISO 1110) | | |
| Molding shrinkage [%] | longitudinal: 1.0 | longitudinal: 1.2 |
| | transverse: 1.0 | transverse: 1.2 |

#measured at: −20° C. to 23° C.

The data in Table 3 show that Composition 3 according to the invention, which comprises the hydrophobing agent D1, has marked advantages in terms of the elastic modulus in the conditioned state, the coefficient of expansion and the molding shrinkage by comparison with V3 which comprises the hydrophobing agent D2.

TABLE 4

| | 4 | V5 |
|---|---|---|
| Components | | |
| A4 | 47.7 | 47.7 |
| B2 | 10.5 | 10.5 |
| C2 | 30 | 30 |
| D1 | 7 | — |
| D2 | — | 7 |
| G4 | 0.3 | 0.3 |
| G5 | 3.06 | 3.06 |
| G7 | 1.4 | 1.4 |
| Properties | | |
| Coefficient of linear expansion# | longitudinal: 65 | longitudinal: 72 |
| [ppm/K] | transverse: 69 | transverse: 85 |
| Molding shrinkage [%] | longitudinal: 2.0 | longitudinal: 2.2 |
| | transverse: 1.6 | transverse: 1.7 |

#measured at: −20° C. to 23° C.
V = comparison

The data in Table 4 show that Composition 4 according to the invention, which comprises the hydrophobing agent D1, features marked advantages regarding the coefficient of expansion and the molding shrinkage in comparison with V5 which comprises the hydrophobing agent D2.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A molding composition comprising
(A) 40 to 90 parts by weight polyamide
(B) 0.5 to 50 parts by weight impact modifier
(C) 0 to 50 parts by weight of one or more filler and reinforcing agents and
(D) 0.1 to 15 parts by weight of a member selected from the group consisting of phenol-formaldehyde resin, an oligomeric compound having at least 2 phenolic hydroxyl groups per molecule and a polymeric compound having at least 2 phenolic hydroxyl groups per molecule, said oligomeric compound and polymeric compound being different from said phenol-formaldehyde resins, wherein the sum of the parts by weight of all the components is 100.

2. The composition according to claim 1, further containing at least one further component selected from
E) a compatibility promoter and
F) a vinyl (co)polymer.

3. The composition according to claim 1, wherein the polyamide is at least one member selected from the group consisting of (co)polyamide-6, (co)polyamide-66, polyamides whereof the acid component included at least one acid selected from the group consisting of terephthalic acid, isophthalic acid, suberic acid, sebacic acid, azelaic acid, adipic acid and cyclohexanedicarboxylic acid and where the diamine component includes at least one member selected from the group consisting of m-methyl-diaminodicyclohexyl methane, laurinlactam from terephthalic acid and the isomer mixture of 2,2,4- and/or 2,4,4-trimethylhexamethylene diamine.

4. The composition according to claim 1 wherein the polyamide is at least one member selected from the group consisting of (co)polyamide-6 and (co)polyamide-66.

5. The composition according to claim 1 wherein component B) is a graft polymers of B.1 from 5 to 95% of at least one vinyl monomer on B.2 from 95 to 5.% one or more graft backbones having a glass transition temperature <10° C., the % both occurrences being relative to the weight of B.

6. The composition according to claim 5, wherein the component B) is the product of polymerization of
B.1.1 50 to 99% relative to the weight of B.1 of at least one monomer selected from the group consisting of vinyl aromatics, vinyl aromatics substituted in the ring and (meth)acrylic acid-(C₁-C₈)-alkyl ester and
B.1.2 1 to 50% relative to the weight of B.1 of at least one monomer selected from the group consisting of vinyl cyanides, (meth)acrylic acid-(C₁-C₈)-alkyl ester and derivatives of unsaturated carboxylic acids, on
B.2 at least one graft backbone selected from the group consisting of diene rubbers, EP(D)M rubbers, polyacrylate rubbers, polyurethane rubbers, silicone rubbers, chloroprene rubbers and ethylene/vinyl acetate rubbers.

7. The composition according to claim 6, wherein the graft backbone is selected from the group consisting of polybutadiene and copolymers of butadiene having styrene and/or methyl (meth)acrylate as comonomers.

8. The composition according to claim 1, wherein component B) is selected from the group consisting of ethylene-propylene rubber and ethylene-propylene-diene rubber.

9. The composition according to claim 1, wherein component C) is at least one member selected from the group consisting of glass fibers, glass spheres, and silicates.

10. The composition according to claim 2, wherein component E) is a thermoplastic polymers of
E.1 a vinyl-aromatic monomer,
E.2 at least one monomer selected from the group consisting of C₂ to C₁₂-alkyl methacrylates, C₂ to C₁₂-alkyl acrylates, methacrylonitriles and acrylonitriles and
E.3 α-, β-unsaturated component which comprise dicarboxylic acid anhydrides.

11. The composition according to claim 10, wherein component E) is a copolymer of styrene, acrylonitrile and maleic acid anhydride.

12. The composition according to claim 2, wherein component F) is a (co)polymers of
F.1 from 50 to 99 wt. % of at least one member selected form the group consisting of vinyl aromatics, vinyl aromatics substituted in the ring and (meth)acrylic acid-(C₁-C₈)-alkyl ester, and
F.2 from 1 to 50 wt. % of at least one member selected from the group consisting of vinyl cyanides and (meth)acrylic acid-(C₁-C₈)-alkyl esters,
the wt % being relative to the weight of component F).

13. The composition according to claim 1 further containing at least one member selected from the group consisting of flame retardants, anti-drip agents, inorganic compounds different from component C), lubricants and mold release agents, nucleating agents, antistatic agents, stabilizers, dyes and pigments.

14. A molded article comprising the composition of claim 1.
